(19) United States
(12) Patent Application Publication
(10) Pub. No.: US 2009/0157345 A1
(43) Pub. Date: Jun. 18, 2009

(54) Detector device for detecting component density contained in mixture fuel

(75) Inventors: Tetsuo Yoshioka, Okazaki-city (JP); Kenji Fukumura, Kariya-city (JP); Takahiko Yoshida, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/314,462

(22) Filed: Dec. 11, 2008

(30) Foreign Application Priority Data
Dec. 12, 2007 (JP) 2007-321225

(51) Int. Cl. G06F 15/00; G01K 17/00; G01N 9/36

(52) U.S. Cl. 702/136; 702/137; 374/E17.001

(57) ABSTRACT

A detector device of the present invention detects densities of components, such as gasoline and ethanol, contained in mixture fuel even when some water is included in the mixture fuel. The detector device includes a sensor having a pair or electrodes, an electronic device for calculating the densities and a memory device for storing permittivities of pure components including water measured beforehand. Alternating current having two different frequencies f1, f2 is applied to the pair of electrodes immersed in the mixture fuel to detect the permittivities of the mixture fuel under f1 and f2. The two frequencies, f1 and f2, are so chosen that the premittivities of gasoline and ethanol show no change between f1 and f2, while the permittivitiy of water shows a substantial difference between f1 and f2. The electronic device calculates the densities of the components based on permittivities of the mixture fuel detected by the sensor and those of components stored in the memory device.

### CROSS-REFERENCE TO RELATED APPLICATION

This application is based upon and claims benefit of priority of Japanese Patent Application No. 2007-321225 filed on Dec. 12, 2007, the content of which is incorporated herein by reference.

### BACKGROUND OF THE INVENTION

1. Field of the Invention

The present invention relates to a detector device for detecting a density of a component contained in mixture fuel.

2. Description of Related Art

An example of such a detector device is disclosed in JP-A-5-87764. A conventional detector device including this example will be briefly described. The detector device detects a density of a component such as ethanol contained in mixture fuel composed of, e.g., gasoline and ethanol. A pair of electrodes is immersed in the mixture fuel and alternating voltage is applied to the electrodes to thereby measure a permittivity of the mixture fuel. Since the permittivity of the mixture fuel is determined based on a frequency of the applied alternating voltage and densities of components contained in the mixture fuel, the density of one component (a focused component) can be calculated from the permittivity detected by applying alternating voltage having a known frequency. In this manner, a density of either gasoline or ethanol contained in the mixture fuel is detected.

However, the following problem is involved in the conventional detector device. It is known that some water is often mixed with the mixture fuel containing main components such as gasoline and ethanol. Water maybe mixed with the mixture fuel at a refinery stage or when the mixture fuel contacts atmospheric air containing water. Further, water may be inadvertently mixed with the mixture fuel by a person carrying or handling the mixture fuel. In the conventional detector device, the density of a component is detected without considering that water may be included in the mixture fuel. In other words, the density of a component is detected under an assumption that the mixture fuel is composed of only the main components. Therefore, the density of a component detected by the conventional detector device may include an error if water is contained in the mixture fuel. Although gasoline is usually composed of several-hundreds of ingredients, gasoline can be handled as a single component because the permittivity of all ingredients is substantially the same.

### SUMMARY OF THE INVENTION

The present invention has been made in view of the above-mentioned problem, and an object of the present invention is to provide an improved detector device for accurately detecting a density of a component contained in mixture fuel.

Mixture fuel composed of gasoline and ethanol is used as a fuel for a gasoline engine. In order to control operation of the engine under optimum conditions, density of the mixture fuel has to be detected. According to the present invention, the density of the mixture fuel is detected by a detector device even when some water is contained in the mixture fuel.

The detector device includes a sensor having a pair of electrodes, an electronic device for calculating the density of the component in the mixture fuel and a memory device for storing permittivities of pure components. The pair of electrodes are immersed in the mixture fuel flowing through a fuel conduit, and alternating voltage having two frequencies f1 and f2, different from each other is applied to the electrodes. The permittivities of pure components are measured under the two frequencies f1, f2 and stored in the memory device.

The frequencies (a first frequency f1 and a second frequency f2) of the alternating voltage are chosen, so that the permittivities of gasoline and ethanol show no change between f1 and f2 while the permittivity of water shows a considerable change between f1 and f2. The first frequency f1 may be set in a frequency range from 50 kHz to 500 kHz, and the second frequency f2 may be set in a frequency range from 500 kHz to 10 MHz. The density of each component (gasoline, ethanol and water) in the mixture fuel is calculated based on a difference of the permittivities of the mixture fuel detected under f1 and f2 and permittivities of the pure components measured under f1 and f2 and stored in the memory device.

The mixture fuel is not limited to the mixture fuel composed of gasoline and ethanol as main components. The present invention may be applied to other mixture fuel such as mixture fuel for a Diesel engine containing light oil and fatty acid methyl ester as main components. A portion of the electrode contacting the mixture fuel may be covered with an insulating film to avoid chemical reactions between the electrode and the mixture fuel.

According to the present invention, the densities of components contained in the mixture fuel are accurately detected even if some water is included in the mixture fuel. Other objects and features of the present invention will become more readily apparent from a better understanding of the preferred embodiment described below with reference to the following drawings.

### BRIEF DESCRIPTION OF THE DRAWINGS

FIG. 1 is a block diagram showing an entire structure of a detector device for detecting a density of a component contained in mixture fuel according to the present invention;

FIG. 2 is a partial cross-sectional view showing a sensor disposed in mixture fuel in a fuel conduit;

FIG. 3 is a graph showing a relative permittivity of water, ethanol and gasoline in relation to frequencies of alternating voltage applied to sensor electrodes;

FIG. 4 is a partial cross-sectional view showing a modified form of the sensor disposed in mixture fuel in a fuel conduit; and

FIG. 5 is a block diagram showing an entire structure of a modified form of a detector device.

### DETAILED DESCRIPTION OF THE PREFERRED EMBODIMENT

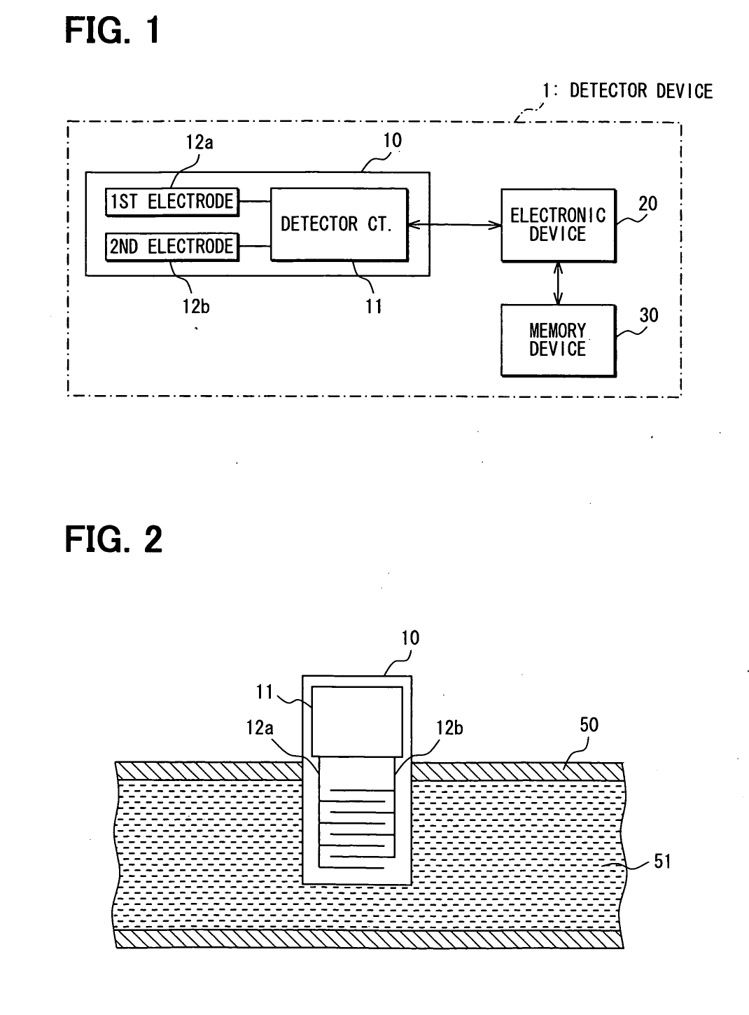

A preferred embodiment of the present invention will be described with reference to FIGS. 1-3. First, referring to FIGS. 1 and 2, a structure of the detector device 1 for detecting a density of a focused component (such as water) contained in mixture fuel composed of gasoline and ethanol. As shown in FIG. 2, a sensor 10 for detecting a permittivity ε of the mixture fuel 51 is installed in a fuel conduit 50 through which the mixture fuel 51 flows.

The sensor 10 includes a pair of electrodes 12a, 12b and a detector circuit 11. An alternating voltage V is applied to the pair of electrodes 12a, 12b to measure a capacitance of the pair of electrodes to thereby detect a permittivity ε of the mixture fuel. Each electrode 12a, 12b is formed in a comb-shape, and the pair of electrodes is formed by combining the comb-shaped electrodes in a zigzag form.

A capacitance C of the pair of electrodes 12a, 12b is determined according to the frequency of the alternating voltage applied to the electrodes 12a, 12b, densities of the components contained in the mixture fuel and kinds of components contained in the mixture fuel. The capacitance C is expressed by the formula: C=α·ε, where α is a constant determined by a size and a shape of the pair of electrodes 12a, 12b. The detector circuit 11 calculates the permittivity ε of the mixture fuel base on the capacitance C and the constant α. Since the way of detecting the permittivity of the mixture fuel is well known, it is not explained here in detail.

The density of gasoline or ethanol contained in the mixture fuel is conventionally determined under an assumption that the mixture fuel is composed of gasoline and ethanol, without containing water therein. However, in an actual situation some water is usually contained in the mixture fuel for the reasons mentioned above. In this actual situation, it should be assumed that the mixture fuel is composed of gasoline, ethanol and water. In order to accurately detect a density of a component contained in the mixture fuel even if water is also contained therein, two frequencies, a first frequency f1 and a second frequency f2, are used in applying the alternating voltage to the pair of electrodes 12a, 12b. The frequencies f1, f2 are chosen, so that the permittivities of both gasoline and ethanol do not change between both frequencies f1, f2 while the permittivity of water changes between frequency f1 and frequency f2.

Generally, the permittivity of a substance uniquely changes according to frequencies due to polarization characteristics of molecules forming the substance, which is known as a dielectric alleviation phenomenon. For example, a peak of a dielectric loss appears when an alternating voltage in a high frequency region is applied to a substance. The permittivity of a substance also changes, due to its conductivity, ions and conductive impurity contained in the substance, when an alternating voltage in a low frequency region is applied thereto.

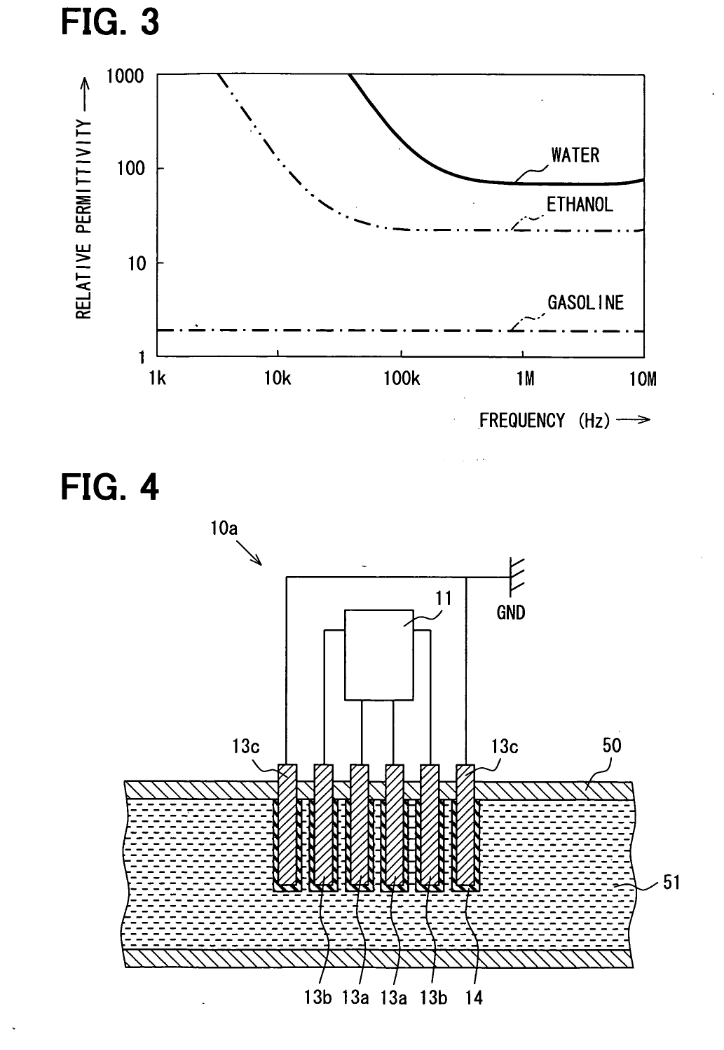

FIG. 3 shows the relative permittivity of gasoline, ethanol and water in relation to frequencies of an alternating voltage applied thereto. The relative permittivity shown in FIG. 3 is calculated from the permittivity measured by the sensor 10 shown in FIGS. 1, 2 at a room temperature of 20° C. when there is a pure substance (no impurity), i.e., gasoline, ethanol or water, respectively. In the case of gasoline, its relative permittivity is substantially constant at 2 under all frequencies throughout 10 Mhz to 1 kHz. In the case of ethanol, its relative permittivity is substantially constant at 24 from 10 MHz to 50 kHz, while showing a sharp increase up to over 1000 under frequencies of 50 kHz or lower. In the case of water, its relative permittivity is substantially flat at 80 under the frequencies from 10 MHz to 500 kHz, while showing a sharp increase up to over 1000 under frequencies of 500 kHz or lower.

In this embodiment, a first frequency f1 is chosen from a frequency range from 50 kHz to 500 kHz where the permittivities of gasoline and ethanol show no change. A second frequency f2 is chosen from a frequency range from 500 kHz to 10 MHz where permittivities of all of gasoline, ethanol and water show no change. When the alternating voltages of frequency f1 and frequency f2 are applied to the pair of electrodes 12a, 12b, the permittivities of gasoline and ethanol do not change between f1 and f2, while the permittivity of water shows a considerable change between f1 and f2.

As shown in FIG. 1, the detector device 1 includes an electronic device 20 that calculates a density of water “c”, a density of gasoline “a” and a density of ethanol “b” based on permittivity ε1 of the mixture fuel detected at frequency f1, the permittivity ε2 of the mixture fuel detected at frequency f2, and permittivities of each component (pure component) measured beforehand at f1, f2 and stored. The permittivities of each component are detected beforehand and stored in a memory device 30 included in the detector device 1.

It is known that the permittivity of the mixture fuel 51 becomes substantially equal to a sum of products of a density and permittivity of each component contained in the mixture fuel. In this particular embodiment (assumed that the mixture fuel is composed of gasoline, ethanol and water), the permittivity ε1 of the mixture fuel measured at f1 and the permittivity ε2 of the mixture fuel measured at f2 are expressed by the following formulae:

ε1=εa1·a+εb1·b+εc1·c

ε2=εa2·a+εb2·b+εc2·c

where εa1, εb1 and εc1 are permittivities of gasoline, ethanol and water, respectively, measured at frequency f1; εa2, εb2 and εc2 are permittivities of gasoline, ethanol and water, respectively, measured at frequency f2; and a, b and c are the densities of gasoline, ethanol and water, respectively. As shown in the graph of FIG. 3, εa1=εa2 and εb1=εb2. Accordingly, a difference between ε1 and ε2 is expressed by the following formula:

(ε1−ε2)=(εc1−c2)·c

The density c of water (focused component) is expressed by:

c=(ε1−ε2)/(εc1−εc2)

This means that the density of the focused component water is calculated based on the detected permittivities ε1, ε2 of the mixture fuel and stored permittivities of water εc1, εc2. The density “a” of gasoline and the density “b” of ethanol are expressed by the following formulae:

a={ε1−εb1+(εb1−εc1)·c}/(εa1−εb1)

b=1−a−c

To calculate the density a, b, c of each component (gasoline, ethanol and water), at least εa1, εb1, εc1 and εc2 have to be known. Therefore, the permittivities of the pure components (gasoline, ethanol and water) are measured under frequencies f1, f2 beforehand and stored in the memory device 30.

As described above, the permittivity ε1 of the mixture fuel 51 is measured by applying the alternating voltage having frequency f1, and the permittivity ε2 of the mixture fuel is measured by applying the alternating voltage having frequency f2. The electronic device 20 calculates the density “c” of water (focused component) contained in the mixture fuel based on the measured permittivity ε1, ε2 and the permittivity of water memorized in the memory device 30. That is, the density of the water “c” is calculated according to the formula: c=(ε1−ε2)/(εc1−εc2). The density “a” of gasoline and the density “b” of ethanol are calculated based on “c” and the permittivities of each component memorized in the memory device 30 according to the formulae shown above.

The second frequency f2 is set in the frequency range from 500 kHz to 10 MHz where the permittivities of all of the components (gasoline, ethanol and water) do not change even if the frequency f2 fluctuates. Therefore, the permittivity ε2 of the mixture fuel detected by the sensor 10 is stable, and influence of temperature changes in the sensor 10 on the detected permittivity can be minimized.

Though the first frequency f1 and the second frequency f2 are chosen from the frequency range from 50 kHz to 500 kHz and the frequency range from 500 kHz to 10 MHz, respectively, in the embodiment described above, it is possible to choose both frequencies f1 and f2 from the same range, e.g., the range from 50 kHz to 500 kHz. The alternating voltage is applied to the sensor electrodes 12a, 12b to avoid formation of electric double layers around the electrodes. If the polarities of the electrodes were not alternate, plus or minus irons in the mixture fuel would be attracted to the electrodes, thereby forming the electric double layers. The permittivity of the mixture fuel can be accurately detected by applying the alternating voltage.

The pair electrodes 12a, 12b is formed by comb-shaped electrodes as shown in FIG. 2. In this manner, a facing area of the pair of electrodes 12a, 12b can be made large, and the electrodes can be formed compact in size.

The present invention is not limited to the embodiment described above, but it maybe variously modified. For example, The detector circuit 11 may be disposed outside of the sensor 10, and it may be disposed somewhere in the detector device 1. Though the electronic device 20 and the memory device 30 are disposed outside of the sensor 10 in the foregoing embodiment, they may be included in the sensor 10. The shape of the electrodes 12a, 12b is not limited to the comb-shape. The electrodes 12a, 12b may be made in a form of flat plates or in a co-axial cylindrical form.

As shown in FIG. 4, the sensor 10 may be modified to a form of sensor 10a. In this modified form, grounded third electrodes 13c are added to suppress noises superimposed on the alternating voltage and to thereby improve detection accuracy. The sensor 10a includes two first electrodes 13a and two second electrodes 13b, and all the electrodes are covered with an insulating film 14 to avoid chemical reactions between the mixture fuel 51 and the electrodes. The sensor 10a includes the detector circuit 11 therein.

The alternating voltage applied to the sensor electrodes is not limited to the sinusoidal wave voltage. It may be a rectangular wave voltage or a triangular wave voltage, for example. Though the alternating voltage is preferable to avoid formation of electric double layers, it may be possible to use a voltage other than the alternating voltage if the permittivity of the mixture fuel is quickly detected before the electric double layers are formed.

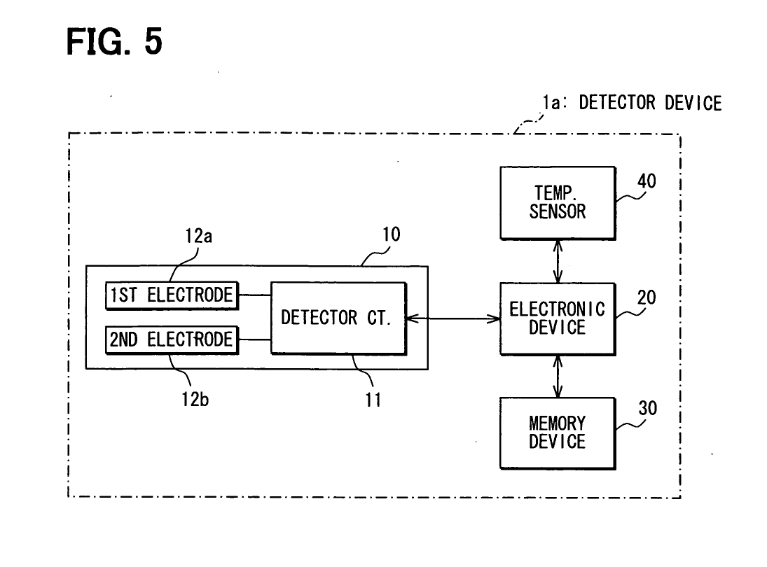

As shown in FIG. 5, a temperature sensor 40 for measuring temperature of the mixture fuel may be added, and the memory device 30a that memorizes the permittivities of the respective components (gasoline, ethanol and water) in relation to the temperature detected by the temperature sensor 40 may be used in a modified detector device la. The permittivity of the mixture fuel at a present temperature is detected by the sensor 10, and the density of the focused component (water) and the densities of other components (gasoline and ethanol) at the present temperature are calculated based on the detected permittivity and the permittivities memorized in the memory device 30a. If the present temperature is different from the temperature memorized together with the permittivity, the densities (a, b, c) of the components may be calculated based on the memorized permittivity adjusted under interpolation. The temperature sensor 40 shown in FIG. 5 may be included in the detector circuit 10.

The density “a” of the gasoline contained in the mixture fuel and the density “b” of the ethanol contained in the mixture fuel may be calculated according to the following formulae in place of the formulae shown above:

a=1−b−c

b={εa2−(εa2−εc2)·c−ε2}/(εa2−εb2)

In this case, at least permittivity εa2 of gasoline measured at frequency f2, permittivity εb2 of ethanol measured at frequency f2, permittivity εc1 of water measured at frequency f1 and permittivity εc2 of water measured at frequency f2 have to be memorized in the memory device 30 (or 30a).

In the foregoing embodiment, it is assumed that the mixture fuel is composed of gasoline, ethanol and water. It is possible, however, to assume that the mixture fuel is composed of gasoline and ethanol (water is not included). In this case, the densities (a, b) of gasoline and ethanol are calculated according to the following formulae: b=1−a; a=1−b

The present invention may be applied to mixture fuel composed of other than three components, gasoline, ethanol and water. In any case, two different frequencies have to be set, so that permittivities of components other than a focused component do not change between two frequencies, and a permittivity of the focused component changes between two frequencies. The density of the focused component is calculated based on permittivities of the mixture fuel detected under the two frequencies and permittivities of the focused component measured under the two frequencies and stored in the memory device.

The present invention is applied to the mixture fuel composed of mainly gasoline and ethanol that is used in a gasoline engine in the embodiment described above. The present invention may be applied to mixture fuel mainly composed of light oil and fatty acid methyl ester that is used in a Diesel engine. The present invention may be widely applied to other mixture fuels such as those containing flex fuel or biochemical light oil.

In the foregoing embodiment, a density of a focused component such as water contained in mixture fuel is detected. In this case, the focused component is known as water. If a kind of a focused component is unknown, the permittivity of the focused component cannot be measured beforehand. In this case, the density of the focused component cannot be detected. However, it is possible to detect that an unknown component is mixed with the mixture fuel by continuously monitoring changes in the permittivity (ε1 or ε2) of mixture fuel.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A detector device for detecting a density of a component contained in mixture fuel, the detector device comprising:
a sensor having a pair of electrodes for detecting permittivity of the mixture fuel by measuring a capacitance between the pair of electrodes to which alternating voltage is applied; and
an electronic device for calculating a density of a focused component contained in the mixture fuel based on the detected permittivity of the mixture fuel and a permittivity of the focused component stored in the detector device, wherein:
the alternating voltage having a first frequency and a second frequency is applied to the pair of electrodes, frequency by frequency;
the first frequency and the second frequency are chosen, so that the permittivity of each component other than the focused component shows substantially no difference between the first frequency and the second frequency while the permittivity of the focused component shows a substantial difference between the first frequency and the second frequency; and
the density of the focused component is calculated based on a difference between the permittivities of the mixture fuel detected under the first frequency and the second frequency and stored permittivities of the focused component measured under the first frequency and the second frequency.

2. The detector device as in claim 1, wherein the electronic device calculates the density “c” of the focused component contained in the mixture fuel according to the following formula:
c=(ε1−ε2)/(Εc1−εc2), where ε1 is the permittivity of the mixture fuel detected under the first frequency f1, ε2 is the permittivity of the mixture fuel detected under the second frequency f2, εc1 is the permittivity of the focused component detected under f1 and stored in the detector device, and εc2 is the permittivity of the focused component detected under f2 and stored in the detector device.

3. The detector device as in claim 1, wherein the electronic device calculates densities of a first component and a second component other than the focused component contained in the mixture fuel based on the permittivities of the first component and the second component detected beforehand under the two frequencies and stored in the detector device and the density of the focused component calculated by the electronic device, under an assumption that the mixture fuel is composed of the first component, the second component and the focused component.

4. The detector device as in claim 3, wherein the electronic device calculates the density “a” of the first component and the density “b” of the second component according to the following formulae:
a={ε1−b1+(εb1−εc1)·c}/(εa1−εb1)
b=1−a−c,
where ε1 is the permittivity of the mixture fuel detected under f1, εb1 is a permittivity of the second component measured under f1, εc1 is a permittivity of the focused component measured under f1, c is the density of the focused component and εa1 is a permittivity of the first component measured under f1.

5. The detector device as in claim 1, wherein the detector device further includes a memory device that stores permittivities of the focused component measured beforehand under the first frequency and the second frequency.

6. The detector device as in claim 5, further including a temperature sensor for detecting temperature of the mixture fuel, wherein the memory device stores permittivities of the focused component measured beforehand in relation to a temperature at a time when the permittivity is measured.

7. The detector device as in claim 1, wherein the alternating voltage applied to the pair of electrodes is a sinusoidal wave voltage.

8. The detector device as in claim 1, wherein the alternating voltage applied to the pair of electrodes is either a rectangular wave voltage or a triangular wave voltage.

9. The detector device as in claim 1, wherein a part of the pair of electrodes contacting the mixture fuel is covered with an insulating film.

10. The detector device as in claim 1, wherein each one of the pair of electrodes is shaped in a comb-shape.

11. The detector device as in claim 1, wherein the mixture fuel is composed of gasoline, ethanol and water.

12. The detector device as in claim 1, wherein the first frequency is chosen from a frequency range from 50 kHz to 500 kHz, and the second frequency is chosen from a frequency range from 500 kHz to 10 MHz.

13. The detector device as in claim 11, wherein both of the first frequency and the second frequency are chosen from a frequency range from 50 kHz to 500 kHz.

14. The detector device as in claim 1, wherein the mixture fuel is composed of light oil, fatty-acid methyl ester and water.
